(19) United States
(12) Patent Application Publication
(10) Pub. No.: US 2004/0123709 A1
(43) Pub. Date: Jul. 1, 2004

(54) SYSTEM FOR SENSING USER CONTACT WITH A SAW BLADE

(75) Inventor: James I Metzger JR., Ballwin, MO (US)

Correspondence Address: HOWREY SIMON ARNOLD & WHITE LLP, ATTEN. DOCKETING DEPT. (A), 750 BERING DRIVE, HOUSTON, TX, 77057, US

(73) Assignee: EMERSON ELECTRIC CO., St. Louis, MO (US)

(21) Appl. No.: 10/248,236

(22) Filed: Dec. 30, 2002

(51) Int. Cl. B26D 5/20

(52) U.S. Cl. 83/76.1

(57) ABSTRACT

A sensing system for sensing user contact with a saw blade. The sensing system includes an electrode situated adjacent the saw blade that creates a capacitor in series with the capacitance of the blade to ground to form a first leg of a bridge circuit. A reference capacitor is connected to the first leg to form a second leg of the bridge circuit. A voltage source is coupled to the bridge to selectively energize the-bridge. Contact of the blade by a user is sensed when the bridge is unbalanced due to the increase in the capacitance of the blade to ground caused by the user's contact with the blade.

### BACKGROUND OF INVENTION

1. Field of the Invention

The present invention relates generally to power saws, and more particularly, to a system for sensing user contact with a moving object such as a saw blade.

2. Description of Related Art

Emergency brakes have been used on saws having a rotating blade for a variety of purposes, including preventing injury caused by human contact with the saw blade. Various means have been disclosed to sense human contact with the blade and actuate an emergency braking device. These sensing mechanisms include, for example, proximity sensors such as capacitive and laser detection types. Based on a predetermined signal from the sensing mechanism, a brake is activated to stop the rotation of the blade.

Known systems for sensing contact with a saw blade tend to be complicated and difficult to implement. Further, many such prior art systems tend to be unreliable. The present application addresses these shortcomings associated with the prior art.

### SUMMARY OF INVENTION

In one aspect of the present invention, a'sensing system for sensing user contact with a saw blade is provided. The saw blade is mounted to an arbor shaft to rotate therewith. The sensing system includes an electrode situated adjacent the arbor shaft or the saw blade that forms a capacitor in series with the capacitance of the blade to ground to form a first leg of a bridge circuit. A reference capacitor is connected to the first leg to form a second leg of the bridge circuit. Third and fourth legs of the bridge may be made up, for example, of resistors and/or capacitors, and these elements are variable in exemplary embodiments to facilitate balancing of the bridge.

A voltage source, such as a high frequency oscillator, is coupled to the bridge to selectively energize the bridge. Contact of the blade by a user is sensed when the bridge is unbalanced due to the increase in the capacitance of the blade to ground caused by the user's contact with the blade, resulting in an output that can be used to trigger an alarm or some means of stopping the blade. In certain exemplary embodiments, the electrode comprises a tubular electrode through which the arbor shaft extends in a spaced relationship. In other exemplary embodiments, the electrode comprises and antenna plate situated close to the blade.

### BRIEF DESCRIPTION OF DRAWINGS

Other objects and advantages of the invention will become apparent upon reading the following detailed description and upon reference to the drawings in which:

FIG. 1 pictorially illustrates a saw system in accordance with aspects of the present invention.

FIG. 2 is a block diagram conceptually illustrating an antenna plate and saw blade in accordance with an exemplary embodiment of the present invention.

FIG. 3 illustrates portions of an insulating hub and a saw blade in accordance with an exemplary embodiment of the present invention.

FIG. 4 is a circuit diagram illustrating a system for sensing user contact with a saw blade in accordance with an embodiment of the present invention.

FIGS. 5 and 6 are circuit diagrams illustrating alternative systems for sensing user contact with a saw blade in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

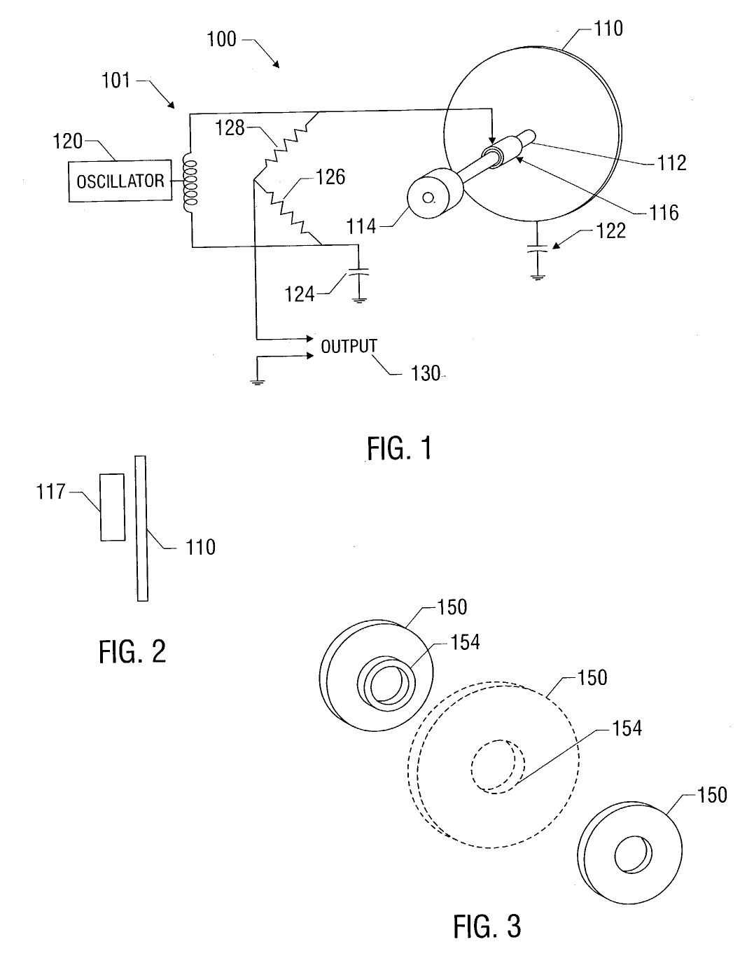

FIG. 1 pictorially illustrates a saw system 100 including a circuit 101 for sensing user contact with the saw blade in accordance with aspects of the present invention. The system 100 includes a saw blade 110 mounted on an arbor shaft 112, which is connected to a frame (not shown for simplicity) in a conventional manner so as to rotate relative thereto. The arbor shaft 112 maybe driven by a belt connected to a pulley 114, also in a conventional manner. An electrode is situated adjacent the arbor shaft 112 and/or the blade 110. In the illustrated embodiment, the electrode is in the form of a tubular electrode 116, through which the arbor shaft 112 extends in a spaced relationship, and the arbor shaft 112 and blade 110 are electrically isolated from the frame.

In other embodiments, the tubular electrode 116 may be replaced by an antenna plate situated close to the blade 110. Such an arrangement is conceptually illustrated in FIG. 2, which shows an antenna plate 117 situated adjacent the saw blade 110. If the antenna plate 117 is used as the electrode, an insulating hub structure may be used to mount the blade 110 on a grounded arbor shaft 112, eliminating the need for electrically isolating the shaft 112 from the frame of the saw. For example, FIG. 3 shows an insulating hub that includes first and second washers 150,152 that are made of an electrically insulating material. The electrically insulating material can include materials such as polyester plastic or any other suitable materials. The first washer 150 has a hub 154 configured to extend into the aperture 156 of the saw blade 112, so that when the blade 110 is mounted on the arbor shaft 112, the saw blade 110 is electrically isolated from the arbor shaft 112.

The electrode 116,117 and the shaft 112 or blade 110 form a capacitor in series with the capacitance 122 of the blade to ground. This capacitance is connected with a reference capacitor 124 and first and second resistors 126,128 to form a bridge. A voltage source, such as a high frequency oscillator 120, is coupled to the bridge. If a massive or grounded object, such as a user of the saw, touches the blade 110, the total capacitance to ground is increased. This imbalances the bridge, and the resulting output 130 is used to trigger a brake or other means of stopping the blade 110.

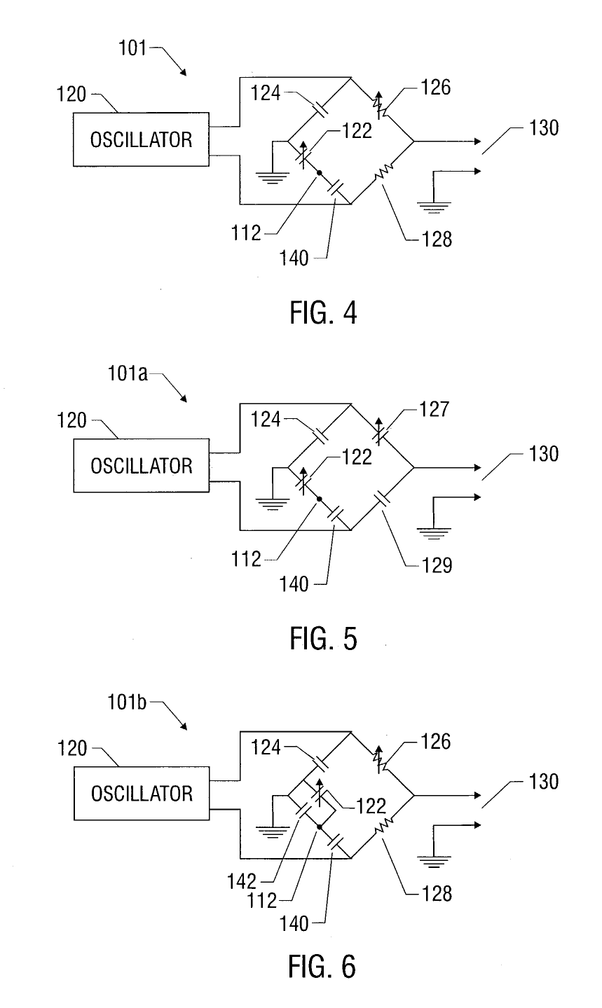

FIG. 4 shows the sensing portion 101 of the system 100 in a circuit diagram. The capacitor 140 represents the capacitor established by the electrode 116,117 and the isolated shaft 12 and/or blade 110. The capacitor 140 is coupled in series with the capacitance of the blade to ground 122. The series capacitors 140,122, the capacitor 124 and the resistors 126,128 are connected as a bridge. One or both of the resistors 126,128 may be variable resistors to balance the bridge—in FIG. 4, the resistor 126 is shown as a variable resistor. The capacitance 122 is shown as a variable capacitance, because it will increase in response to a massive and/or grounded object, such as a user, touching the blade 110. Such an increase in capacitance will unbalance the bridge, and the resulting output 130 from the bridge is used to trigger a brake or other means of stopping the blade 110.

In other embodiments, the variable resistor 126 comprises an electronically variable element, such as a field effect transistor, allowing the bridge to be balanced automatically. For example, the bridge could be balanced upon startup to compensate for a different blade 110. The balance may also be adjusted during operation to compensate for slow changes in the environment of the blade 110 while still preserving circuit response to rapid changes, such as a user contact with the blade 110.

In still further embodiments, the resistors 126 and 128 making up two legs of the bridge, are replaced by capacitors. FIG. 5 shows an alternative sensing portion 101a in which capacitors 127,129 make up two legs of the bridge to create a pure capacitance bridge, avoiding mixing capacitance and resistance in the bridge. As with the resistors 126,128 shown in FIG. 4, one of both of the capacitors 127,129 may be variable to balance the bridge. In FIG. 5, the capacitor 127 is a variable capacitor. In certain embodiments, the variable capacitor 127 may be an electronically variable element, such as a varactor, to allow automatically balancing the bridge.

Another exemplary embodiment of a sensing portion 101b is shown in FIG. 6, in which an additional capacitor 142 is connected in parallel with the capacitance of the blade to ground 122. The capacitor 142 may comprise a small capacitor used for added stability and to reduce sensitivity to minor variations in the blade to ground capacitance 122. In some embodiments, the small capacitor is provided on the motor controller circuit board, for example.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A saw system, comprising:
a frame;
an arbor shaft mounted to the frame to rotate relative thereto;
a blade mounted on the arbor shaft to rotate therewith;
an electrode situated adjacent the blade creating a capacitor in series with the capacitance of the blade to ground to form a first leg of a bridge circuit;
a reference capacitor connected to the first leg to form a second leg of the bridge circuit; and
a voltage source coupled to the bridge;
wherein contact of the blade by a user increases the capacitance of the blade to ground and unbalances the bridge.

2. The saw system of claim 1, wherein the voltage source comprises an oscillator.

3. The saw system of claim 1, wherein the blade and the arbor shaft are electrically isolated from the frame, and wherein the electrode comprises a tubular electrode that receives the arbor shaft.

4. The saw system of claim 1, wherein the electrode comprises an antenna plate situated adjacent the blade.

5. The saw system of claim 4, wherein the blade is electrically isolated from the arbor shaft.

6. The saw system of claim 5, wherein the blade defines an opening therethrough for receiving the arbor shaft, the saw system further comprising:
a first insulating washer situated on one side of the blade, the first insulating washer having a hub received by the opening in the blade; and
a second insulating washer situated on the opposite side of the blade.

7. The saw system of claim 1, wherein the bridge includes a third leg connected to the second leg, and a fourth leg connected to the third and first legs.

8. The saw system of claim 7, wherein the third leg includes a first resistor connected to the second leg, and the fourth leg includes a second resistor connected to the third and first legs.

9. The saw system of claim 8, wherein at least one of the first or second resistors is a variable resistor.

10. The saw system of claim 9, wherein the variable resistor comprises an electronically variable element.

11. The saw system of claim 10, wherein the electronically variable element comprises a field effect transistor.

12. The saw system of claim 7, wherein the third leg includes a first capacitor connected to the second leg, and the fourth leg includes a second capacitor connected to the third and first legs.

13. The saw system of claim 12, wherein at least one of the first or second capacitors is a variable capacitor.

14. The saw system of claim 13, wherein the variable capacitor comprises an electronically variable element.

15. The saw system of claim 14, wherein the electronically variable element comprises a varactor.

16. A sensing system for sensing user contact with a saw blade, the saw blade being mounted to an arbor shaft, the sensing system comprising:
an electrode situated adjacent the blade creating a capacitor in series with the capacitance of the blade to ground to form a first leg of a bridge circuit;
a reference capacitor connected to the first leg to form a second leg of the bridge circuit; and
a voltage source coupled to the bridge;
wherein contact of the blade by a user increases the capacitance of the blade to ground and unbalances the bridge.

17. The sensing system of claim 16, wherein the voltage source comprises an oscillator.

18. The sensing system of claim 16, wherein the arbor shaft is electrically isolated from a frame of the saw, and wherein the electrode comprises a tubular electrode that receives the arbor shaft.

19. The sensing system of claim 16, wherein the electrode comprises an antenna plate situated adjacent the blade.

20. The sensing system of claim 19, wherein the blade is electrically isolated from the arbor shaft.

21. The sensing system of claim 16, wherein the bridge includes a third leg connected to the second leg, and a fourth leg connected to the third and-first legs.

22. The sensing system of claim 22, wherein the third leg includes a first resistor connected to the second leg, and the fourth leg includes a second resistor connected to the third and first legs.

23. The sensing system of claim 23, wherein at least one of the first or second resistors is a variable resistor.

24. The sensing system of claim 22, wherein the third leg includes a first capacitor connected to the second leg, and the fourth leg includes a second capacitor connected to the third and first legs.

25. The sensing system of claim 25, wherein at least one of the first or second capacitors is a variable capacitor.

26. A sensing system for sensing user contact with a saw blade, the saw blade being mounted to an arbor shaft that is electrically isolated from a frame of the saw, the sensing system comprising:
means for forming a capacitor in series with the capacitance of the blade to ground to form a first leg of a bridge circuit;
a reference capacitor connected to the first leg to form a second leg of the bridge circuit;
a third leg connected to the second leg of the bridge circuit;
a fourth leg connected to the third and first legs of the bridge circuit; and means for energizing the bridge circuit;
wherein contact of the blade by a user increases the capacitance of the blade to ground and unbalances the bridge.
